(19) United States
(12) Patent Application Publication
(10) Pub. No.: US 2017/0201378 A1
(43) Pub. Date: Jul. 13, 2017

(54) ELECTRONIC DEVICE AND METHOD FOR AUTHENTICATING IDENTIFICATION INFORMATION THEREOF

(71) Applicant: Samsung Electronics Co., Ltd., Gyeonggi-do (KR)

(72) Inventors: Kyungmoon KIM, Gyeonggi-do (KR); Jaeyoung Lee, Seoul (KR); Myeongjin Oh, Gyeonggi-do (KR)

(73) Assignee: Samsung Electronics Co., Ltd.

(21) Appl. No.: 15/405,755

(22) Filed: Jan. 13, 2017

(30) Foreign Application Priority Data
Jan. 13, 2016 (KR) 10-2016-0004376

(51) Int. Cl. H04L 9/32; H04L 29/06

(52) U.S. Cl. CPC H04L 9/3247; H04L 63/06; H04L 63/08; H04L 63/061; H04L 63/0853

(57) ABSTRACT

An electronic device is provided. The electronic device includes a communication interface; a memory configured to store first identification information corresponding to an external electronic device and second identification information corresponding to a communication processor (CP) of the external electronic device, and a processor, wherein the processor is configured to generate authentication information based on at least the first identification information and the second identification information, generate an electronic signature corresponding to the authentication information through encryption of at least a part of data related to the authentication information, and transmit the electronic signature to the external electronic device using the communication interface.

### PRIORITY

This application claims priority under 35 U.S.C. §119(a) to a Korean Patent Application filed on Jan. 13, 2016 in the Korean Intellectual Property Office and assigned Serial No. 10-2016-0004376, the entire disclosure of which is incorporated herein by reference.

### BACKGROUND

1. Field of the Disclosure

The present disclosure relates generally to an electronic device, and more particularly, to an electronic device having unique identification information.

2. Description of the Related Art

With the development of mobile communication technology and processor technology, a portable terminal device (hereinafter an electronic device) has various functions in addition to an existing calling function. Examples of various functions of an electronic device may be a camera function, a multimedia reproduction function, and the execution of various applications, and in order to execute such various functions, the electronic device may be provided with high-end hardware and software which may cause the price of the electronic device to increase.

A manufacturer of an electronic device and a communication company may provide various services using identification information of the electronic device. For example, firmware or an operating system (OS) of an electronic device may be updated in a wireless method, such as over the air (OTA).

As the price of an electronic device increases, identification information of an electronic device may be forged or altered through illegal copying of identification information of another electronic device to obtain an update or promotion of the electronic device. Since identification information of an electronic device is uniquely determined for each electronic device, but may be rewritten in a memory, identification information may be illegally obtained using hacking tools of a large number of hackers or hacker companies to cause a serious problem, such as the creation of illegally copied phones through illegal copying of identification information of an electronic device.

In order to prevent the illegal use of identification information, an electronic device in the related art may store encrypted identification information. Since the number of electronic devices that are actually produced and distributed may be almost infinite, it is not possible to encrypt the identification information using different encryption keys for the respective electronic devices. On the other hand, using the same encryption key may cause a security vulnerability.

### SUMMARY

An aspect of present disclosure is to provide schemes for preventing identification information that is a unique value of an electronic device from being maliciously copied, forged, or altered by subjects except for a manufacturer of the electronic device.

In accordance with an aspect of the present disclosure, an electronic device is provided. The electronic device includes a communication interface; a memory configured to store first identification information corresponding to an external electronic device and second identification information corresponding to a communication processor (CP) of the external electronic device; and a processor, wherein the processor is configured to generate authentication information based on at least the first identification information and the second identification information, generate an electronic signature corresponding to the authentication information through encryption of at least a part of data related to the authentication information, and transmit the electronic signature to the external electronic device using the communication interface.

In accordance with another aspect of the present disclosure, a method of generating, by an electronic device, an electronic signature corresponding to authentication information of an external electronic device is provided. The method includes receiving, by the electronic device, first identification information corresponding to the external electronic device; receiving, by the electronic device, second identification information corresponding to a CP of the external electronic device; generating, by the electronic device, authentication information based on at least the first identification information and the second identification information; generating, by the electronic device, an electronic signature corresponding to the authentication information through encryption of at least a part of data related to the authentication information; and transmitting, by the electronic device, the electronic signature to the external electronic device.

In accordance with another aspect of the present disclosure, an electronic device is provided. The electronic device includes a communication interface including a CP; a memory configured to store first identification information corresponding to the electronic device, second identification information corresponding to the CP, and an electronic signature received from an external electronic device; and at least one processor configured to generate data related to first authentication information corresponding to the electronic device through decryption of the electronic signature, generate data related to second authentication information based on at least the first identification information and the second identification information, compare data related to the first authentication information with data related to the second authentication information, and perform authentication of the electronic device based on at least the result of the comparison.

In accordance with another aspect of the present disclosure, a method of authenticating, by an electronic device, identification information is provided. The method includes generating, by the electronic device, data related to first authentication information corresponding to the electronic device through decryption of an electronic signature that is received from an external electronic device; generating, by the electronic device, data related to second authentication information based on at least first identification information corresponding to the electronic device and second identification information corresponding to a CP of the electronic device; comparing, by the electronic device, data related to the first authentication information with data related to the second authentication information; and performing, by the electronic device, authentication of the electronic device based on at least the result of the comparison.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of an electronic device in a network environment according to an embodiment of the present disclosure;

FIG. 2 is a block diagram of an electronic device according to an embodiment of the present disclosure;

FIG. 3 is a block diagram of a program module according to an embodiment of the present disclosure;

FIG. 4 is a diagram of an electronic device, an electronic signature device, an identification information generation device, and a key server according to an embodiment of the present disclosure;

FIG. 5 is a block diagram of an electronic signature device according to an embodiment of the present disclosure;

FIG. 6 is a flowchart of a method of causing an electronic signature device to generate an electronic signature corresponding to authentication information of an electronic device according to an embodiment of the present disclosure;

FIG. 7 is a block diagram of an electronic device according to an embodiment of the present disclosure;

FIG. 8 is a flowchart of a method of causing an electronic device to authenticate identification information according to an embodiment of the present disclosure; and

FIG. 9 is a flowchart of a method performed after an electronic device authenticates identification information according to an embodiment of the present disclosure.

### DETAILED DESCRIPTION OF EMBODIMENTS OF THE PRESENT DISCLOSURE

Hereinafter, embodiments of the present disclosure are described in detail with reference to the accompanying drawings. While the present disclosure may be embodied in many different forms, certain embodiments of the present disclosure are shown in the accompanying drawings and are described herein in detail, with the understanding that the present disclosure is intended to be considered as an exemplification of the principles of the present disclosure and is not intended to limit the present disclosure to the embodiments illustrated. The same reference numbers are used throughout the accompanying drawings to refer to the same or like parts.

The terms “comprising” or “may comprise” used in the present disclosure indicate the presence of a corresponding function, operation, or element but do not limit additional at least one function, operation, or element. Further, in the present disclosure, the terms “comprise” and “have” indicate the presence of a characteristic, numeral, step, operation, element, component, or combination thereof described in a specification but do not exclude the presence or addition of at least one other characteristic, numeral, step, operation, element, component, or combination thereof.

In the present disclosure, the term “or” includes any combination or the entire combination of words listed together. For example, “A or B” may include A, B, or A and B.

An expression of a first and a second in the present disclosure may represent various elements of the present disclosure, but does not limit corresponding elements. For example, the expression does not limit order and/or importance of corresponding elements. The expression may be used for distinguishing one element from another element. For example, both a first user device and a second user device are user devices but represent different user devices. For example, a first element may be referred to as a second element without deviating from the scope and spirit of the present disclosure, and similarly, a second element may be referred to as a first element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not intended to limit the present disclosure but illustrate embodiments. When used in a description of the present disclosure and the appended claims, a singular form includes a plural form unless it is explicitly indicated otherwise.

Unless otherwise defined, terms used herein have the same meanings as may be generally understood by a person of ordinary skill in the art. It should be interpreted that generally used terms defined in a dictionary have meanings corresponding to those of a context of related technology and are not intended to be interpreted in an ideal or excessively formal manner unless explicitly defined.

In the present disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a moving picture experts group audio layer 3 (MP3) player, a portable medical device, a digital camera, or a wearable device (e.g., a head-mounted device (HMD) such as electronic glasses, electronic clothes, an electronic bracelet, an electronic necklace, an electronic appcessory, or a smart watch).

According to an embodiment of the present disclosure, an electronic device may be a smart home appliance that involves a communication function. For example, an electronic device may be a TV, a digital video disk (DVD) player, audio equipment, a refrigerator, an air conditioner, a vacuum cleaner, an oven, a microwave, a washing machine, an air cleaner, a set-top box, a TV box (e.g., Samsung HomeSync®, Apple TV®, Google TV™, etc.), a game console, an electronic dictionary, an electronic key, a camcorder, or an electronic picture frame.

According to an embodiment of the present disclosure, an electronic device may be a medical device (e.g., a magnetic resonance angiography (MRA) device, a magnetic resonance imaging (MRI) device, a computed tomography (CT) device, an ultrasonography device, etc.), a navigation device, a global positioning system (GPS) receiver, an event data recorder (EDR), a flight data recorder (FDR), a car infotainment device, electronic equipment for a ship (e.g., a marine navigation system, a gyrocompass, etc.), avionics, security equipment, or an industrial or home robot.

According to an embodiment of the present disclosure, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are present as examples only and are not intended to be considered as a limitation of the present disclosure.

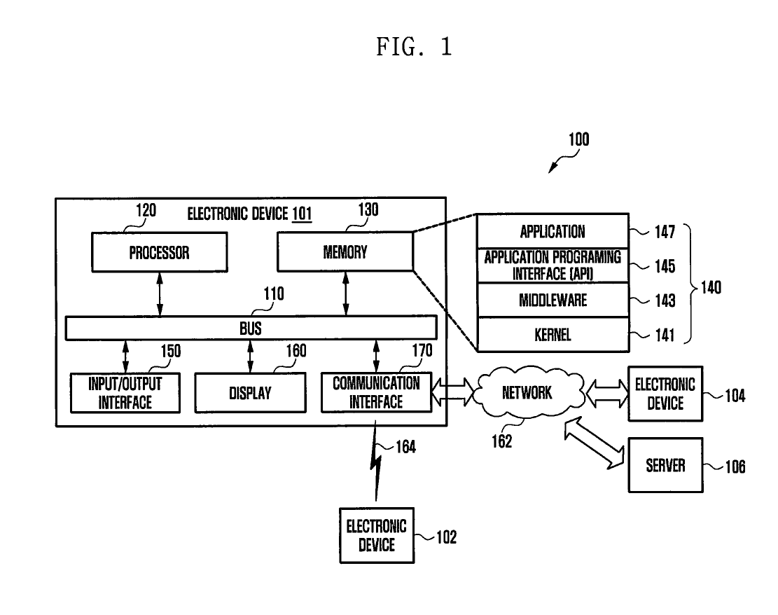

FIG. 1 is a block diagram of an electronic device 101 in a network environment 100 according to an embodiment of the present disclosure.

Referring to FIG. 1, the electronic device 101 may include a bus 110, a processor 120, a memory 130, a user input interface 150, a display 160, and a communication interface 170.

The bus 110 may be a circuit for interconnecting elements described above and for allowing communication, e.g. by transferring a control message, between the elements described above.

The processor 120 may receive commands from the above-mentioned other elements, e.g. the memory 130, the user input/output interface 150, the display 160, and the communication interface 170, through, for example, the bus 110, may decipher the received commands, and perform operations and/or data processing according to the deciphered commands.

The memory 130 may store commands received from the processor 120 and/or other elements, e.g. the input/output interface 150, the display 160, and the communication interface 170, and/or commands and/or data generated by the processor 120 and/or other elements. The memory 130 may include software and/or programs 140, such as a kernel 141, middleware 143, an application programming interface (API) 145, and an application 147. Each of the programming modules described above may be configured by software, firmware, hardware, and/or combinations of two or more thereof.

The kernel 141 may control and/or manage system resources, e.g. the bus 110, the processor 120 or the memory 130, used for execution of operations and/or functions implemented in other programming modules, such as the middleware 143, the API 145, and/or the application 147. Further, the kernel 141 may provide an interface through which the middleware 143, the API 145, and/or the application 147 may access and then control and/or manage an individual element of the electronic device 101.

The middleware 143 may perform a relay function which allows the API 145 and/or the application 147 to communicate with and exchange data with the kernel 141. Further, in relation to operation requests received from at least one of an application 147, the middleware 143 may perform load balancing in relation to operation requests by, for example, giving a priority in using a system resource, e.g. the bus 110, the processor 120, and/or the memory 130, of the electronic device 101 to at least one application from among the at least one of the application 147.

The API 145 is an interface through which the application 147 may control a function provided by the kernel 141 and/or the middleware 143, and may include, for example, at least one interface or function for file control, window control, image processing, and/or character control.

The input/output interface 150 may receive, for example, a command and/or data from a user, and transfer the received command and/or data to the processor 120 and/or the memory 130 through the bus 110. The display 160 may display an image, a video, and/or data to a user.

The communication interface 170 may establish communication between the electronic device 101 and other electronic devices 102 and 104 and/or a server 106. The communication interface 170 may support short range communication protocols, e.g. a wireless fidelity (WiFi) protocol, a BlueTooth (BT) protocol, and a near field communication (NFC) protocol, communication networks, e.g. the Internet, a local area network (LAN), a wide area network (WAN), a telecommunication network, a cellular network, a satellite network, a plain old telephone service (POTS), or any other similar and/or suitable communication network, such as network 162, or the like. Each of the electronic devices 102 and 104 may be the same type and/or different types of electronic devices.

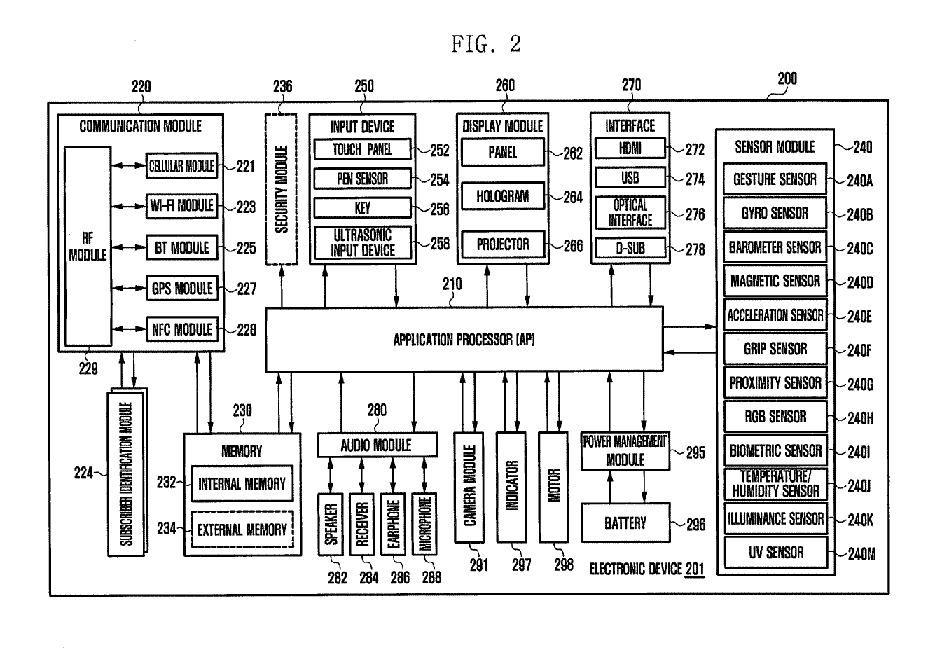

FIG. 2 is a block diagram of an electronic device 201 according to an embodiment of the present disclosure. The electronic device 201 may form, for example, the whole or part of the electronic device 101 shown in FIG. 1.

Referring to FIG. 2, the electronic device 201 may include at least one application processor (AP) 210, a communication module 220, a subscriber identification module (SIM) card 224, a memory 230, a sensor module 240, an input device 250, a display module 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of a system-on-chip (SoC), for example. According to an embodiment of the present disclosure, the AP 210 may further include a graphics processing unit (GPU).

The communication module 220 (e.g., the communication interface 170) may establish communication with any other electronic device (e.g., the electronic device 204 or the server 206) connected to the electronic device 201 through a network. According to an embodiment of the present disclosure, the communication module 220 may include therein a cellular module 221, a WiFi module 223, a BT module 225, a GPS module 227, an NFC module 228, and a radio frequency (RF) module 229.

The cellular module 221 may provide a voice call, a video call, a message service, an internet service, or the like through a communication network (e.g., long term evolution (LTE), LTE advanced (LTE-A), code division multiple access (CDMA), wideband CDMA (WCDMA), universal mobile telecommunications system (UMTS), wireless broadband (WiBro), or global system for mobile communications (GSM), etc.). Additionally, the cellular module 221 may perform identification and authentication of the electronic device 201 in the communication network, using the SIM card 224. According to an embodiment of the present disclosure, the cellular module 221 may perform at least part of the functions the AP 210 may provide. For example, the cellular module 221 may perform at least part of a multimedia control function.

According to an embodiment of the present disclosure, the cellular module 221 may include a CP. Additionally, the cellular module 221 may be formed of an SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment of the present disclosure, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single integrated circuit (IC) or chip, or a single IC package in an embodiment of the present disclosure. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electrical signals. The RF module 229 may include a transceiver, a power amplifier module (PAM), a frequency filter, a low noise amplifier (LNA), or the like. Also, the RF module 229 may include any component, e.g., a wire or a conductor, for transmission of electromagnetic waves in free air. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment of the present disclosure.

The SIM card 224 may be a certain card inserted into a slot formed at a certain location in the electronic device 201. The SIM card 224 may contain therein an integrated circuit card identifier (ICCID) or an international mobile subscriber identity (IMSI).

The memory 230 (e.g., the memory 130) may include an internal memory 232 and an external memory 234. The internal memory 232 may include, for example, at least one of a volatile memory (e.g., dynamic random access memory (DRAM), static RAM (SRAM), synchronous DRAM (SDRAM), etc.) or a nonvolatile memory (e.g., one time programmable read only memory (OTPROM), programmable ROM (PROM), erasable PROM (EPROM), electrically erasable PROM (EEPROM), mask ROM, flash ROM, NAND flash memory, NOR flash memory, etc.).

According to an embodiment of the present disclosure, the internal memory 232 may have the form of a solid state drive (SSD). The external memory 234 may include a flash drive, e.g., a compact flash (CF) drive, a secure digital (SD) drive, a micro SD (Micro-SD) drive, a mini SD (Mini-SD) drive, an extreme digital (xD) drive, a memory stick, or the like. The external memory 234 may be functionally connected to the electronic device 201 through various interfaces. The electronic device 201 may further include a storage device or medium such as a hard drive.

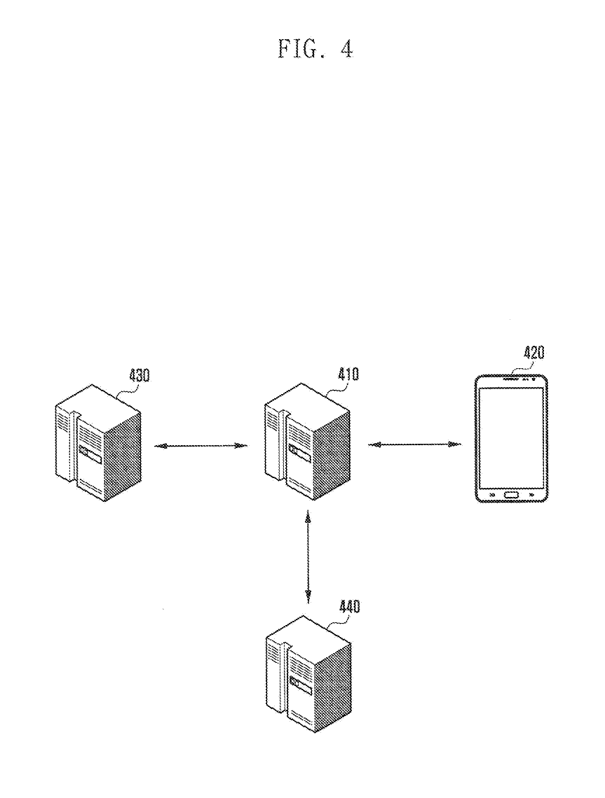

The security module 236 may perform a certification operation of a identification information of the electronic device 201 (e.g., IMEI). The security module 236 may be included in the AP 210. The function of the security module 236 is described below with FIGS. 4 to 9.

The sensor module 240 may measure a physical quantity or sense an operating status of the electronic device 201, and then convert the measured or sensed information into electrical signals. The sensor module 240 may include, for example, at least one of a gesture sensor 240A, a gyro sensor 240B, a barometer sensor 240C, a magnetic sensor 240D, an acceleration sensor 240E, a grip sensor 240F, a proximity sensor 240G, a color sensor 240H (e.g., a red-green-blue (RGB) sensor), a biometric sensor 240I, a temperature-humidity sensor 240J, an illumination sensor 240K, and an ultraviolet (UV) light sensor 240M. Additionally or alternatively, the sensor module 240 may include, e.g., an electronic nose (E-nose) sensor, an electromyography (EMG) sensor, an electroencephalogram (EEG) sensor, an electrocardiogram (EGC) sensor, an infrared (IR) sensor, an iris scan sensor, or a finger scan sensor. Also, the sensor module 240 may include a control circuit for controlling one or more sensors equipped therein.

The input device 250 may include a touch panel 252, a digital pen sensor 254, a key 256, or an ultrasonic input device 258. The touch panel 252 may recognize a touch input in a manner of capacitive type touch panel, resistive type touch panel, infrared type touch panel, or an ultrasonic type touch panel. In addition, the touch panel 252 may further include a control circuit. In the case of a capacitive type touch panel, physical contact or proximity contact may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a certain device capable of identifying data by sensing sound waves with a microphone 288 in the electronic device 201 through an input tool that generates ultrasonic signals, thus allowing wireless recognition. According to an embodiment of the present disclosure, the electronic device 201 may receive a user input from any external device (e.g., a computer or a server) connected thereto through the communication module 220.

The display module 260 (e.g., the display 160) may include a panel 262, a hologram 264, or a projector 266. The panel 262 may be, for example, a liquid crystal display (LCD), an active matrix organic light emitting diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located internally or externally to the electronic device 201. According to an embodiment of the present disclosure, the display module 260 may further include a control circuit for controlling the panel 262, the hologram 264, and the projector 266.

The interface 270 may include, for example, a high-definition multimedia interface (HDMI) 272, a universal serial bus (USB) 274, an optical interface 276, or a D-subminiature (D-sub) connector 278. The interface 270 may be contained, for example, in the communication module 220 shown in FIG. 2. Additionally or alternatively, the interface 270 may include, for example, a mobile high-definition link (MHL) interface, an SD card/multi-media card (MMC) interface, or an Infrared Data Association (IrDA) interface.

The audio module 280 may perform a conversion between sound and an electrical signal. The audio module 280 may process sound information input or output through a speaker 282, a receiver 284, an earphone 286, or the microphone 288.

The camera module 291 is a device capable of obtaining still images and moving images. According to an embodiment of the present disclosure, the camera module 291 may include at least one image sensor (e.g., a front sensor or a rear sensor), a lens, an image signal processor (ISP), or a flash (e.g., a light emitting diode (LED) or xenon lamp).

The power management module 295 may manage electrical power of the electronic device 201. The power management module 295 may include, for example, a power management IC (PMIC), a charger IC, or a battery gauge.

The PMIC may be formed, for example, of an IC or an SoC. Charging may be performed in a wired or wireless manner. A charger IC may charge a battery 296 and prevent overvoltage or overcurrent from a charger. According to an embodiment of the present disclosure, a charger IC may be used for at least one of wired and wireless charging types. Wireless charging may include, for example, magnetic resonance charging, magnetic induction charging, or electromagnetic charging. An additional circuit for wireless charging may be used such as a coil loop, a resonance circuit, or a rectifier.

The battery gauge may measure the residual amount of the battery 296 and a voltage, current or temperature in a charging process. The battery 296 may store or generate electrical power therein and supply electrical power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electrical signal into a mechanical vibration. The electronic device 201 may include a certain processor (e.g., a GPU) for supporting mobile TV. This processor may process media data that comply with standards of digital multimedia broadcasting (DMB), digital video broadcasting (DVB), or media flow.

Each of the above-described elements of the electronic device 201 disclosed herein may be formed of one or more components, and its name may vary according to the type of the electronic device 201. The electronic device 201 disclosed herein may be formed of at least one of the above-described elements, without some elements, or with additional elements. Some of the elements may be integrated into a single entity that performs the same functions as those of such elements before being integrated.

The term “module” used in the present disclosure may refer to a certain unit that includes one of hardware, software, firmware, or any combination thereof. The term “module” may be interchangeably used with unit, logic, logical block, component, or circuit, for example. The term “module” may indicate a minimum unit, or part thereof, which performs one or more functions. The term “module” may indicate a device formed mechanically or electronically. For example, the term “module” disclosed herein may include at least one of an application specific IC (ASIC), a field programmable gate array (FPGA), and a programmable-logic device, which are known or will be developed.

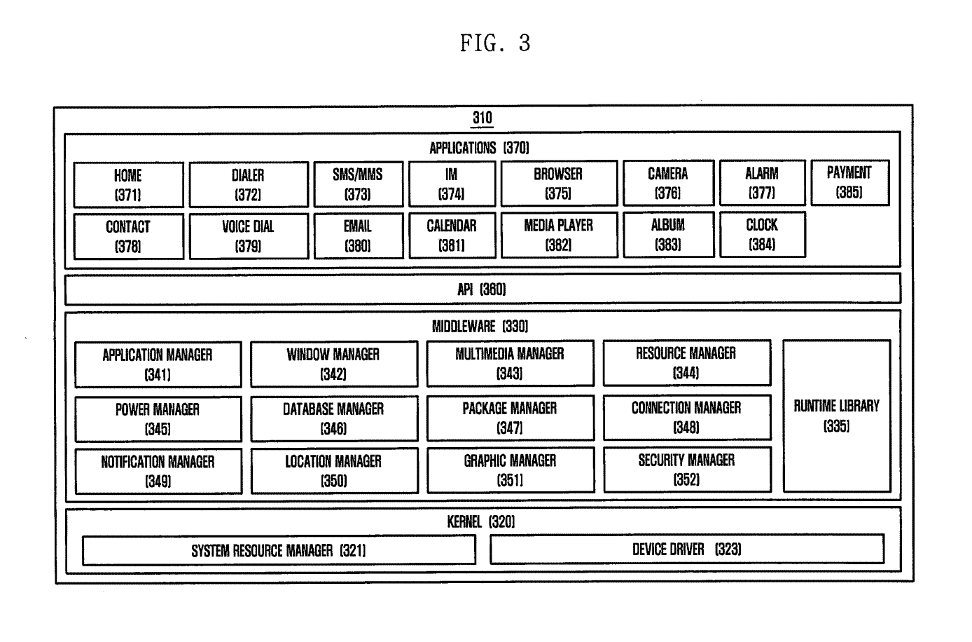

FIG. 3 is a block diagram of a programming module 310 according to an embodiment of the present disclosure.

The programming module 310 may be included (or stored) in the electronic device 101 (e.g., the memory 130) illustrated in FIG. 1 or may be included (or stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware, and may include an OS controlling resources related to an electronic device and/or various applications (e.g., an application 370) executed in the OS. For example, the OS may be Android®, iOS®, Windows®, Symbian™, Tizen®, Bada™, and the like.

Referring to FIG. 3, the programming module 310 may include a kernel 320, middleware 330, an API 360, and/or applications 370.

The kernel 320 (e.g., the kernel 141) may include a system resource manager 321 and/or a device driver 323. The system resource manager 321 may include, for example, a process manager, a memory manager, and a file system manager. The system resource manager 321 may perform the control, allocation, recovery, and/or the like of system resources. The device driver 323 may include, for example, a display driver, a camera driver, a Bluetooth driver, a shared memory driver, a USB driver, a keypad driver, a Wi-Fi driver, and/or an audio driver. In addition, according to an embodiment of the present disclosure, the device driver 323 may include an inter-process communication (IPC) driver.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, a security manager 352, and any other suitable and/or similar manager.

The runtime library 335 may include, for example, a library module, used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on a screen. The multimedia manager 343 may detect a format used to reproduce various media files and may encode or decode a media file through a codec appropriate for the relevant format. The resource manager 344 may manage resources, such as source code, a memory, storage space, and/or the like of at least one of the applications 370.

The power manager 345 may operate with a basic input/output system (BIOS), manage a battery or power, and provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connection manager 348 may manage a wireless connectivity such as, for example, Wi-Fi and Bluetooth. The notification manager 349 may display or report, to a user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device has a telephone function, the middleware 330 may further include a telephony manager for managing a voice telephony call function and/or a video telephony call function of the electronic device.

The middleware 330 may generate and use a new middleware module through various functional combinations of the above-described internal element modules. The middleware 330 may provide modules customized according to types of OSs in order to provide differentiated functions. In addition, the middleware 330 may dynamically delete some of the existing elements, or may add new elements. Accordingly, the middleware 330 may omit some of the elements described in the various embodiments of the present disclosure, may further include other elements, or may replace some of the elements with other elements, each of which performs a similar function but has a different name.

The API 360 (e.g., the API 145) is a set of API programming functions, and may be provided with a different configuration according to an OS. In the case of Android® or iOS®, for example, one API set may be provided for each platform. In the case of Tizen®, for example, two or more API sets may be provided for each platform.

The applications 370 (e.g., the applications 147) may include, for example, a preloaded application and/or a third party application. The applications 370 (e.g., the applications 147) may include, for example, a home application 371, a dialer application 372, a short message service (SMS)/multimedia messaging service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, a payment application 385, and any other suitable and/or similar application.

At least a part of the programming module 310 may be implemented by instructions stored in a non-transitory computer-readable storage medium. When the instructions are executed by one or more processors (e.g., the AP 210), the one or more processors may perform functions corresponding to the instructions. The non-transitory computer-readable storage medium may be, for example, the memory 230. At least a part of the programming module 310 may be implemented (e.g., executed) by, for example, the one or more processors. At least a part of the programming module 310 may include, for example, a module, a program, a routine, a set of instructions, and/or a process for performing one or more functions.

Hereinafter, various embodiments of the present disclosure for preventing identification information of an electronic device from being forged or altered are described in more detail.

According to an embodiment of the present disclosure, identification information of an electronic device may be, for example, international mobile equipment identity (IMEI) information. The IMEI may be provided to mobile electronic devices in accordance with a guideline of the GSM Association (GSMA), and more specifically, the IMEI may be generated by an identification information generation device and may be provided to an electronic device when the electronic device is manufactured. The IMEI is a decimal number having 15 digits in total including 2 digits for distinguishing the manufacturer of the electronic device, 6 digits for distinguishing the model (or device type) of the manufacturer, 6 digits for distinguishing the serial number of the electronic device, and 1 digit for a checksum, where the IMEI may be registered and managed in a database (DB) of the third generation partnership project (3GPP).

The IMEI is distinguished for each electronic device, and may be distinguished from an IMSI, a mobile identity number (MIN), or a mobile directory number (MDN), which is for distinguishing a subscriber in a mobile communication network.

Hereinafter, the IMEI will be described as an example of the identification information of the electronic device, but the present disclosure is not intended to be limited thereto. Various pieces of data that may be used to identify the electronic device, such as a mobile equipment identifier (MEID), may correspond to the identification information of the electronic device.

FIG. 4 is a diagram of an electronic device 420, an electronic signature device 410, an identification information generation device 440, and a key server 430 according to an embodiment of the present disclosure.

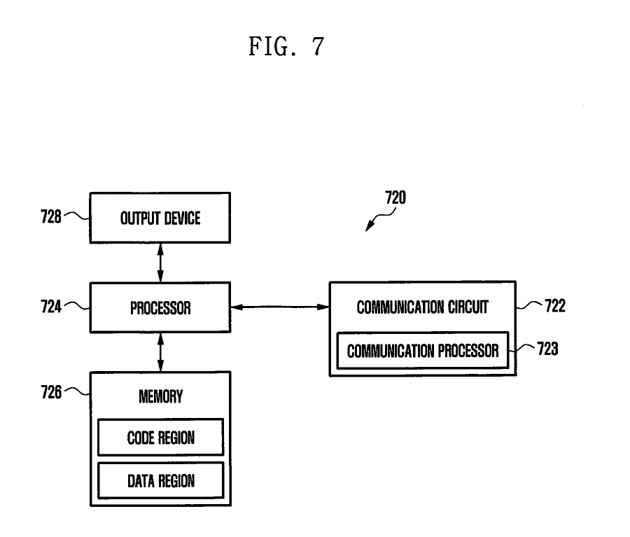

An electronic device 420 according to an embodiment of the present disclosure may include a portable mobile device, such as a smart phone or a tablet PC, which may be carried by a user. The electronic device 420 includes configurations of a processor, a memory, and a communication circuit, and the detailed configuration of the electronic device 420 is described below with reference to FIG. 7.

An identification information generation device 440 according to an embodiment of the present disclosure may indicate a device that generates identification information to be allocated to the electronic device 420 during manufacturing of the electronic device 420. The identification information generation device 440 may allocate the identification information (e.g., IMEI) to the electronic device 420 according to a guideline that is determined in GSMA or the like, and may provide the allocated identification information to the electronic device 420 through an electronic signature device 410. Hereinafter, the identification information that is provided to the electronic device 420 is referred to as first identification information.

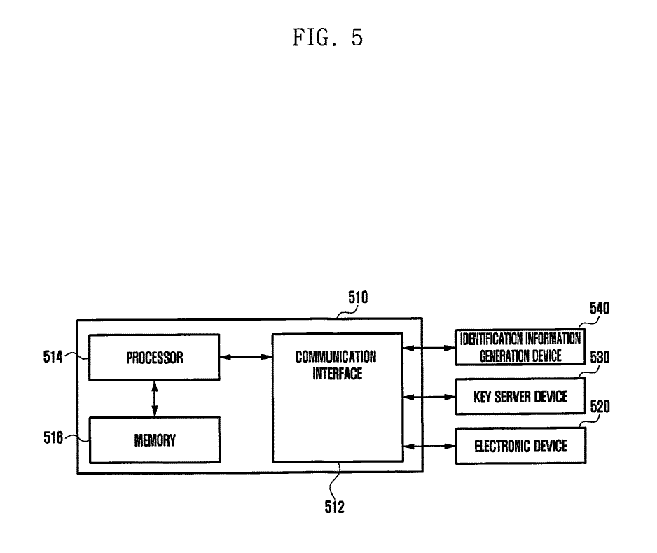

The electronic signature device 410 according to an embodiment of the present disclosure may encrypt authentication information that includes the identification information (or first identification information) of the electronic device 420 to transmit the encrypted authentication information to the electronic device 420. The electronic signature device 410 may use an asymmetric key encryption method, such as a Rivest-Shamir-Adleman (RSA) algorithm, during generation of the electronic signature of the authentication information. The detailed configuration and operation of the electronic device 410 is described below with reference to FIG. 5.

A key server 430 according to an embodiment of the present disclosure may store an encryption key that is used to encrypt the authentication information in the electronic signature device 410. The key server 430 may be accessed only by a manufacturer side including the electronic signature device 410, and thus it may be impossible for subjects other than the manufacturer to acquire the encryption key. The encryption key may include a secret key (or private key or non-public key).

As described below, since the electronic signature of the authentication information that is generated by the electronic signature device 410 is unable to be copied unless the encryption key that is stored in the key server 430 is secured, and subjects other than the manufacturer are unable to access the key server 430, the identification information of the electronic device 420 may be prevented from being illegally forged or altered through a security operation of the key server 430.

FIG. 5 is a block diagram of an electronic signature device 510 according to an embodiment of the present disclosure.

Referring to FIG. 5, the electronic signature device 510 includes a communication interface 512, a processor 514, and a memory 516, where there is no difficulty in implementing an embodiment of the present disclosure even if at least a part of FIG. 5 is omitted or replaced. The electronic signature device 510 may correspond to the electronic signature device 410 of FIG. 4 as described above.

In an embodiment of the present disclosure, the communication interface 512 may receive a unique value of a CP from an electronic device 520 when the communication interface 512 is connected to the electronic device 520, where the unique value of the CP may include an identity (ID) of the CP that is included in a communication circuit of the electronic device 520. Hereinafter, the unique value of the CP may be referred to as second identification information. The communication interface 512 may provide an electronic signature that is generated as described below to the electronic device 520.

In an embodiment of the present disclosure, the communication interface 512 may receive a secret key and/or a public key corresponding to the secret key to be used for encryption of authentication information from a key server 530 when the communication interface 512 is connected to the key server 530. The communication interface 512 may be connected to the key server 530 through a network.

In an embodiment of the present disclosure, the communication interface 512 may receive identification information of the electronic device 520 from the identification information generation device 540. In this case, the identification information may be an IMEI as described above, and the IMEI may be composed of 15 digits in total including 2 digits for distinguishing the manufacturer of the electronic device, 6 digits for distinguishing the model (or device type) of the manufacturer, 6 digits for distinguishing the serial number of the electronic device, and 1 digit for a checksum.

In an embodiment of the present disclosure, the memory 516 may include a volatile memory and a nonvolatile memory, but the present disclosure is not limited thereto. The memory 516 may store the first identification information (or identification information of the electronic device 520) corresponding to the electronic device 520 that is received from the identification information generation device 540 and/or the second identification information (or unique value of the CP) corresponding to the CP of the electronic device 520 that is received from the electronic device 520. The memory 516 may be electrically connected to the processor 514, and may store various instructions that may be performed by the processor 514. In this case, the instructions may be defined on a process tool that performs generation of the identification information of the electronic device 520 and encryption of the authentication information.

In an embodiment of the present disclosure, the processor 514 may be configured to load the instructions stored in the memory 516 and to perform functions defined by the instructions.

In an embodiment of the present disclosure, the processor 514 may receive the unique value of the CP that is included in the electronic device 520 from the electronic device 520 connected to the communication interface 512. The unique value of the CP is a value that is written in a read only memory (ROM) at a time when a CP chipset is manufactured. The unique value is used to distinguish the CP chipset, and the unique value may be provided for each CP chipset in the process. The unique value of the CP may be written in a one-time programmable (OTP) region of the CP. The OTP region is a region in which data is recorded by hardware during manufacturing of the CP, and thus corresponds to a region where reading data is possible, but rewriting of the once written data is impossible. Accordingly, the unique value of the CP may be information for which modulation is impossible. The unique value of the CP may be stored in another region in which rewrite is impossible after being written on the CP that is not the OTP region.

In an embodiment of the present disclosure, the processor 514 may generate the authentication information based on at least a part of the identification information (or first identification information) of the electronic device 520 stored in the memory 516 and the unique value (or second identification information) of the CP. In this case, the authentication information may be generated by simply combining the unique value of the CP with the back of the identification information of the electronic device 520 that is expressed as a decimal number. For example, when the identification information of the electronic device 520 is “1000” and the identification information of the CP is “2000”, the authentication information may be generated as “10002000”. The electronic device 520 may include various chipsets, such as APs having respective unique values except for the CP. However, since the unique value of the AP is stored, for example, in a rewritable region, such as a NAND flash region, forgery or alteration thereof may be easily performed. When generating the authentication information, the processor 514 may use the unique value of the CP that is written in the OTP region in which forgery/alteration is impossible, and according to an embodiment of the present disclosure, the processor 514 may use the unique value of at least one of other elements in the electronic device 520, which stores the unique value in the region in which rewrite is impossible, like the OTP region, other than the unique value of the CP.

In an embodiment of the present disclosure, the processor 514 may generate the electronic signature corresponding to the authentication information through encryption of at least a part of data related to the authentication information. Through the electronic signature, it is possible to prove that the data related to the authentication information is generated by the electronic signature device 520, that is, the manufacturer side of the electronic device 520.

In an embodiment of the present disclosure, the data related to the authentication information may be a hash value of the authentication information. A hash algorithm may compress an input message having a certain length into an output value (a hash value) having a fixed length, and if the hash value is obtained, the number of bits thereof may be less than that of the authentication information. Since a significant amount of time is consumed as the size of data used to create the electronic signature increases, the time that is required for encryption may be reduced by encrypting the hash value of the authentication information other than encrypting the authentication information itself. The processor 514 may omit the process of obtaining a hash value, and may generate an electronic signature through encryption of the authentication information itself. That is, the data related to the authentication information may be the authentication information or the hash value of the authentication information.

In an embodiment of the present disclosure, the processor 514 may generate an electronic signature of the authentication information through an asymmetric key encryption method. The communication interface 512 may receive a secret key from the key server 530, and the processor 514 may generate an electronic signature of the authentication information using the received secret key. As described above, the key server 530 may store encryption keys for respective model names, or may store only one encryption key.

In an embodiment of the present disclosure, the processor 514 may transmit an encryption key request message including a model name of the electronic device 520 to the key server 530 through the communication interface 512, and the key server 530 may transmit a secret key corresponding to the received model name and a public key that matches the corresponding secret key to the electronic signature device 510. The key server 530 may store only one secret key, and may transmit the corresponding secret key and the matching public key to the electronic signature device 510. Accordingly, integrity for the electronic signature of the authentication information may be secured unless the encryption key that is stored in the key server 530 is exposed.

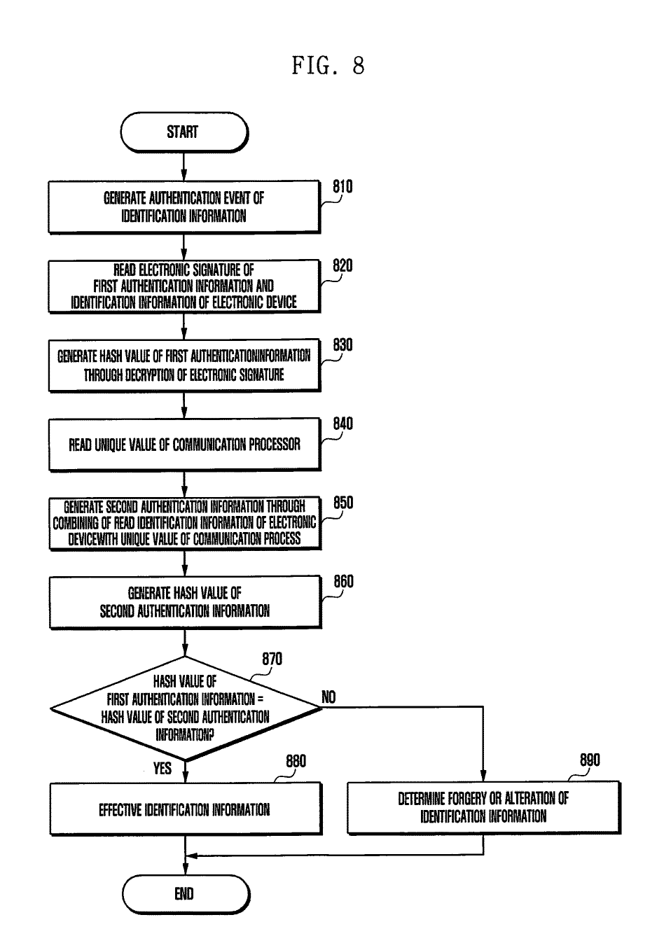

The processor 514 may transmit the generated electronic signature of the authentication information and the generated identification information of the electronic device 520, which are in a combined state, to the electronic device 520 through the communication interface 512. The generated electronic signature of the authentication information and the identification information of the electronic device 520 may be stored in the memory 516 of the electronic device 520 to be used in the identification information authentication process of the electronic device 520 as described below with reference to FIGS. 7 and 8.

An electronic device according to an embodiment of the present disclosure may include a communication interface, a memory configured to store first identification information corresponding to an external electronic device and second identification information corresponding to a CP of the external electronic device, and a processor, wherein the processor may be configured to generate authentication information at least based on the first identification information and the second identification information, to generate an electronic signature corresponding to the authentication information through encryption of at least a part of data related to the authentication information, and to transmit the electronic signature to the external electronic device using the communication interface.

According to an embodiment of the present disclosure, the processor may be configured to transmit the electronic signature in combination with the first identification information to the external electronic device.

According to an embodiment of the present disclosure, the processor may be configured to receive a key value from another external electronic device using the communication interface, and to perform the encryption operation using the key value.

According to an embodiment of the present disclosure, the processor may be configured to generate a hash value of the authentication information, and to generate the electronic signature through encryption of at least a part of the hash value of the authentication information.

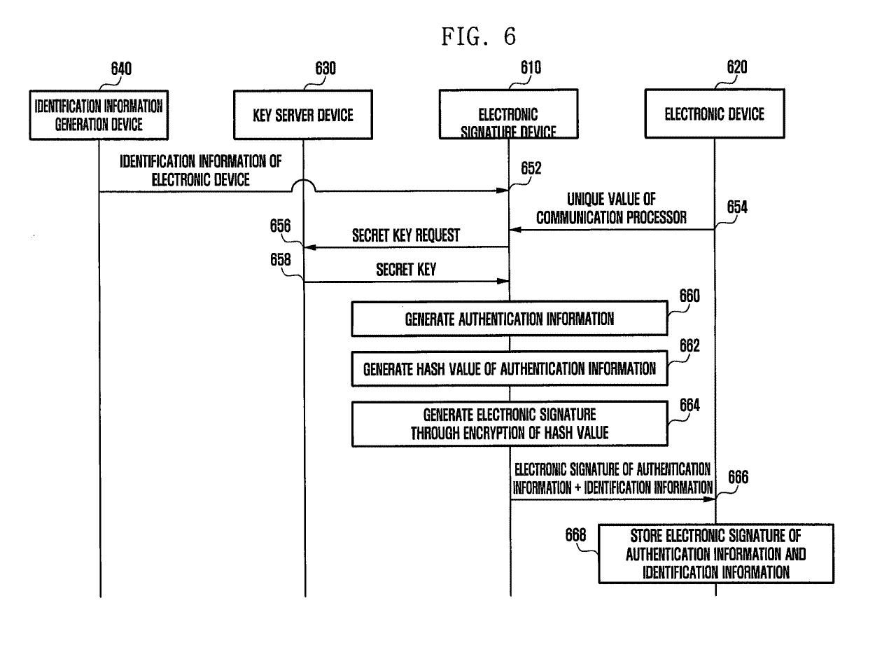

FIG. 6 is a flowchart of a method of causing an electronic signature device to generate an electronic signature corresponding to authentication information of an electronic device according to an embodiment of the present disclosure.

Referring to FIG. 6, the method may be performed by the electronic signature device 410 or 510, the electronic device 420 or 520, the key server 430 or 530, and the identification information generation device 440 or 540 as described above with reference to FIGS. 4 and 5. Hereinafter, explanation of the technical features that have been described above with reference to FIG. 5 is omitted. Further, the operations may be performed during manufacturing of the electronic device 620.

At step 652, an identification information generation device 640 may allocate identification information of the electronic device 620 and may transmit the allocated identification information to an electronic signature device 610. In this case, the identification information may be an IMEI, and may include at least one of various pieces of identification information that may be allocated by a manufacturer to identify the electronic device 620 during manufacturing of the electronic device 620.

At step 654, the electronic device 620 may transmit a unique value of a CP to the identification information generation device 610. According to an embodiment of the present disclosure, the unique value of the CP may include a unique value of a CP that is included in a communication circuit, and the unique value may be a value that has already been written in an OTP region of the CP and thus rewrite thereof is impossible.

At operation 656, the electronic signature device 610 may request a secret key to be used for encryption of the authentication information from the key server 630. The key server 630 may store encryption keys for respective model names of the electronic device 620 or may store only one encryption key. In the case of distinguishing the encryption keys for the respective model names of the electronic device 620, the electronic signature device 610 may transmit an encryption key request message that includes the model name of the electronic device 620 to the key server 630.

At step 658, the key server 630 may transmit the requested secret key to the electronic signature device 610. The key server 630 may transmit the secret key corresponding to the received model name and the public key that matches the corresponding secret key to the electronic signature device 610, or in the case of using only one secret key, the key server 630 may transmit the corresponding secret key and the matching public key to the electronic signature device 610.

At step 660, the electronic signature device 610 may generate the authentication information through combining the allocated identification information with the unique value of the CP that is received from the electronic device 620. In an embodiment of the present disclosure, the electronic signature device 610 may generate the authentication information through simply combining the unique value of the CP with the back of the identification information of the electronic device 620 that is expressed as a decimal number.

At step 662, the electronic signature device 610 may generate a hash value of the authentication information. As the hash value is generated, the amount of processing the operation may be reduced in comparison to a case where the authentication information is encrypted during the encryption, which is described below. In an embodiment of the present disclosure, the electronic signature device 610 may generate the electronic signature through encryption of the authentication information without hashing the authentication information, and, in this case, step 662 may be omitted.

At step 664, the electronic signature device 610 may encrypt data related to the authentication information (e.g., a hash value of the authentication information or authentication information) using the secret key that is received through the key server 630, and may generate the electronic signature of the authentication information. Through the electronic signature, it may be proved that the data related to the authentication information is generated by the electronic signature device 610, that is, the manufacturer side of the electronic device 620.

At step 666, the electronic signature device 610 may transmit the electronic signature of the authentication information and the generated identification information of the electronic device 620, which are in a combined state, to the electronic device 620.

At step 668, the electronic device 620 may store the received electronic signature of the authentication information and the identification information of the electronic device 620 in the memory.

A method for causing an electronic device to generate an electronic signature corresponding to authentication information of an external electronic device according to an embodiment of the present disclosure may include receiving first identification information corresponding to the external electronic device; receiving second identification information corresponding to a CP of the external electronic device; generating authentication information at least based on the first identification information and the second identification information; generating an electronic signature corresponding to the authentication information through encryption of at least a part of data related to the authentication information; and transmitting the electronic signature to the external electronic device.

According to an embodiment of the present disclosure, transmitting the electronic signature may include transmitting the electronic signature in combination with the first identification information to the external electronic device.

According to an embodiment of the present disclosure, the method for causing an electronic device to generate an electronic signature may further include receiving a key value from another external electronic device, and generating the electronic signature may include performing the encryption operation using the key value.

According to an embodiment of the present disclosure, the method of causing an electronic device to generate an electronic signature may further include generating a hash value of the authentication information, and generating the electronic signature may include generating the electronic signature through encryption of at least a part of the hash value of the authentication information.

FIG. 7 is a block diagram of an electronic device 720 according to an embodiment of the present disclosure.

Referring to FIG. 7, the electronic device 720 may be the electronic device 520 of FIG. 5 described above and/or may be the electronic device 620 of FIG. 6 described above. Further, the electronic device 720 may include at least a part of the configurations of the electronic device 101 of FIG. 1 and/or the electronic device 201 of FIG. 2.

The electronic device 720 includes a communication circuit 722, a processor 724, a memory 726, and an output device 728, where there is no difficulty in implementing an embodiment of the present disclosure even if at least a part of FIG. 7 is omitted or replaced. In addition to the electronic device 720 of FIG. 7, the electronic device 720 may further include a display, an input device, and various kinds of sensors. Hereinafter, authenticating identification information of the electronic device 720 is described.

The communication circuit 722 is configured to transmit/receive data with an external device, and may include at least a part of the configurations of the communication interface 170 of FIG. 1 and/or the communication module 220 of FIG. 2. The communication circuit 722 may include a CP 723. The CP 723 is a processor for performing signal processes, such as modulation and demodulation of data that is transmitted or received through an antenna, and may be implemented in one IC or chip.

In an embodiment of the present disclosure, the CP 723 includes a unique value that is allocated when the CP 723 is manufactured, and the unique value is a value that is written together in a ROM at a time when a CP chipset is manufactured. The unique value is used to distinguish the CP chipset, and the unique value may be provided for each CP chipset in the process. The unique value of the CP 723 may be written in an OTP region of the CP 723. The OTP region is a region in which data is recorded by hardware during the manufacturing thereof, and thus corresponds to a region where reading the data is possible, but rewriting of the once written data is impossible. Accordingly, the unique value of the CP 723 may be information of which modulation is actually impossible.

In an embodiment of the present disclosure, the memory 726 may include a volatile memory and a nonvolatile memory, but the present disclosure is not limited thereto. The memory 726 may be electrically connected to the processor 724, and may store various instructions that may be performed by the processor 724. Such instructions may include control commands, such as arithmetic and logic operations, data movement operations, and input/output operations, that may be recognized by the processor 724.

In an embodiment of the present disclosure, the memory 726 may include a code region and a data region. In the data region, first identification information corresponding to the electronic device 720, second identification information corresponding to the CP, and electronic signature of the first authentication information that is received from the electronic signature device may be stored. The identification information (or first identification information) of the electronic device 720 that is stored in the memory 726 may be generated by the identification information generation device 540 or 640 as described above with reference to FIG. 6, and may be provided from the electronic signature device 510 or 610 to the electronic device 720. The electronic signature of the first authentication information may be generated and transmitted by the electronic signature device 510 or 610 during the manufacturing of the electronic device 720. The data region is a region in which rewriting data is possible, and thus the electronic signature of the first authentication information and the identification information of the electronic device 720 may be rewritten. The code region may include a public key to be used when the electronic signature of the first authentication information is decrypted, and the public key may match the secret key that is stored in the key server as described above. In an embodiment of the present disclosure, the public key may be acquired from the key server by the electronic signature device in the process to be provided to the electronic device 720, or may be provided from a customer center of the electronic device 720.

The processor 724 is configured to perform control of respective elements of the electronic device 720 and/or communication related operation or data processing, and may include at least a part of the configurations of the processor 120 of FIG. 1 and/or the AP 210 of FIG. 2. The processor 724 may be electrically connected to various elements of the electronic device 720, such as the communication circuit 722 and the memory 726.

In an embodiment of the present disclosure, for an event for authenticating the identification information of the electronic device 720, the processor 724 may be configured to execute the instructions stored in the memory 726 and to pass through an authentication process described below. The event for authenticating the identification information may be generated, for example, during booting of the electronic device 720.

In an embodiment of the present disclosure, the processor 724 may read the electronic signature of the first authentication information and the identification information of the electronic device 720 stored in the memory 726. In this case, the identification information of the electronic device 720 may be allocated by the identification information generation device during the manufacturing of the electronic device 720 and may be provided from the electronic signature device to the electronic device 720, and the electronic signature of the first authentication information may be generated and transmitted by the electronic signature device 510 or 610 during the manufacturing of the electronic device 720.

The processor 724 may decrypt the electronic signature of the first authentication information that is read from the memory 726 using the public key stored in the memory 726. In this case, the public key matches the secret key that is stored in the key server as described above, that is, the secret key that is used when the electronic signature device encrypts the authentication information, and unless the public key is modulated after the electronic signature of the first authentication information is written in the memory 726, the original message that is generated as the result of the decryption may be data related to the first authentication information before being encrypted by the identification information generation device. In this case, the data related to the first authentication information may be the hash value of the first authentication information or the first authentication information itself.

In an embodiment of the present disclosure, the processor 724 may perform a read operation. As described above, the unique value of the CP 723 may be the unique value that is written in the OTP region. The unique value of the CP may be read from another region other than the OTP region, or may be acquired through another memory that is provided in the network or the electronic device 720.

In an embodiment of the present disclosure, the processor 724 may generate second authentication information through combining the identification information of the electronic device 720 read from the memory 726 with the unique value of the CP 723 read from the communication circuit 722. In this case, the second authentication information may be generated by simply combining the unique value of the communication circuit 722 with the back of the identification information that is expressed by a decimal number. The second authentication information may be generated through a hash function using the identification information (e.g., the IMEI value) of the electronic device 720 and the identification information (e.g., the CP identity) corresponding to the CP.

In an embodiment of the present disclosure, the electronic device 720 may include various chipsets such as an AP having the unique value in addition to the CP 723. However, for example, the unique value of the AP is stored in a rewritable region such as a NAND flash region, where forgery/alteration may be easily performed. The electronic signature device and the electronic device 720 may use the unique value of the CP 723 that is written in the OTP region in which forgery/alteration becomes impossible in the process of generating and authenticating the authentication information, and, the electronic signature device and the electronic device 720 may use the unique value of at least one of the other elements in the electronic device 720 which stores the unique value in the region in which rewriting is impossible, like the OTP region, other than the unique value of the CP 722.

In an embodiment of the present disclosure, if the acquired data related to the first authentication information is the hash value of the first authentication information, the processor 724 may generate a hash value of the second authentication information. If the data related to the first authentication information is the first authentication information, the process of generating the hash value of the second authentication information may be omitted.

In an embodiment of the present disclosure, the data related to the first authentication information is generated by the electronic signature device and is stored in the electronic device 720, and the data related to the second authentication information is generated by the electronic device 720. That is, the data may be generated by different subjects, but may be generated through the same algorithm. Further, since the unique value of the CP 723 is a value written in the OTP region of the CP 723 and its modulation is impossible, and the secret key that is used by the electronic signature device when generating the electronic signature of the first authentication information is not stored in the electronic device 720, but is safely preserved in the key server, the data related to the first authentication information and the data related to the second authentication information may be the same. That is, unless the identification information of the electronic device 720 that is stored in the memory 726 of the electronic device 720 is rewritten, the data related to the first authentication information and the data related to the second authentication information should be the same.

In an embodiment of the present disclosure, the processor 724 may compare the data related to the first authentication information and the data related to the second authentication information with each other, and may perform the authentication of the electronic device 720 depending on whether they coincide with each other. That is, if the data related to the first authentication information and the data related to the second authentication information coincide with each other, the processor 724 may determine that the identification information of the electronic device 720 that is stored in the memory 726 of the electronic device 720 is effective. Unlike this, if data related to the first authentication information and the data related to the second authentication information are different from each other, the processor 724 may determine that the identification information of the electronic device 720 is forged or altered.

In an embodiment of the present disclosure, in the case where the authentication operation is performed during the booting process of the electronic device 720, the electronic device 720 proceeds with the booting process if it is determined that the identification information is effective, whereas the electronic device 720 stops the booting process or may perform the booting in a limited mode in which only a limited operation may be performed if it is determined that the identification information is forged or altered.

In an embodiment of the present disclosure, the processor 724 may be configured to provide notification corresponding to the result of the authentication through the output device 728. The output device 728 may include, for example, at least one of a speaker for audio output, a display for video output, and a vibration actuator for haptic output. The processor 724 may output at least one of the voice output, audio output, and haptic output using the output device 728 in accordance with the authentication result of the identification information of the electronic device 720.

An electronic device according to an embodiment of the present disclosure may include a communication interface including a CP; a memory configured to store first identification information corresponding to the electronic device, second identification information corresponding to the CP, and an electronic signature received from an external electronic device; and at least one processor, wherein the at least one processor is configured to generate data related to first authentication information corresponding to the electronic device through decryption of the electronic signature, to generate data related to second authentication information at least based on the first identification information and the second identification information, to compare data related to the first authentication information with data related to the second authentication information, and to perform authentication of the electronic device at least based on the result of the comparison.

According to an embodiment of the present disclosure, the electronic device may further include an output device, and the processor may be configured to provide a notification corresponding to the result of the authentication through the output device.

According to an embodiment of the present disclosure, the data related to the first authentication information may include a hash value of the first authentication information, and the processor may be configured to generate a hash value of the second authentication information and to determine that the first identification information is effective if the hash value of the first authentication information is equal to the hash value of the second authentication information.

According to an embodiment of the present disclosure, the processor may be configured to perform authentication of the electronic device in a booting process of the electronic device.

FIG. 8 is a flowchart of a method of causing an electronic device to authenticate identification information according to an embodiment of the present disclosure.

Referring to FIG. 8, the method may be performed by the electronic device 720 described above with reference to FIG. 7. Thus, the description above is not repeated.

At step 810, the electronic device may generate an event for authenticating identification information. In this case, the identification information authentication event may occur during booting of the electronic device.

At step 820, the electronic device may read the electronic signature of the first authentication information and the identification information of the electronic device stored in a memory. In this case, the electronic signature of the first authentication information may be received from an external electronic device, that is, an electronic signature device.

At step 830, the electronic device may decrypt the electronic signature of the first authentication information using a public key stored in the memory. As the result of the decryption, data related to the first authentication information is generated, and the data related to the first authentication information may be a hash value of the first authentication information or the first authentication information.

At step 840, the electronic device may read a unique value of a CP. As described above, the unique value of the CP may be the unique value that is written in an OTP region of a CP chipset.

At step 850, second authentication information may be generated through combining the identification of the electronic device that is read from the memory and the unique value of the CP that is read from a communication circuit with each other.

At step 860, the electronic device may generate a hash value of the second authentication information. In addition, the data related to the first authentication information may be the first authentication information itself, and in this case, the step 860 to generate the hash value of the second authentication information may be omitted.

At step 870, the electronic device may compare the data related to the first authentication information and the data related to the second authentication information with each other.

At step 880, if the data related to the first authentication information and the data related to the second authentication information are the same, the electronic device may determine that the identification information that is stored in the memory of the electronic device is effective.

At step 890, if the data related to the first authentication information and the data related to the second authentication information do not coincide with each other, the electronic device may determine that the identification information of the electronic device is forged or altered.

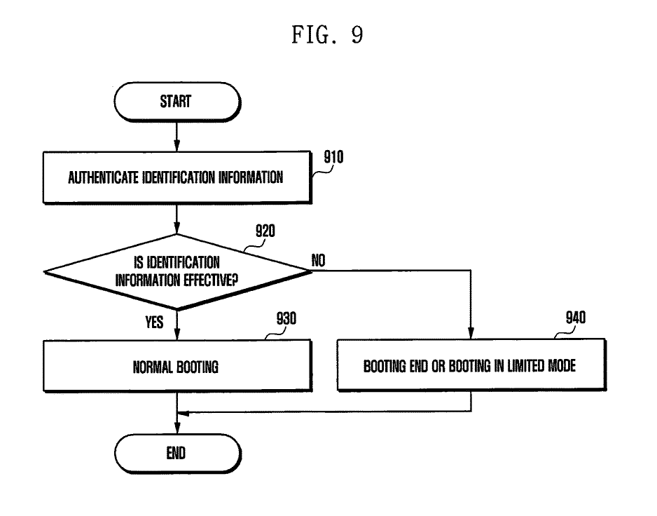

FIG. 9 is a flowchart of a method performed after an electronic device authenticates identification information according to an embodiment of the present disclosure.

Referring to FIG. 9, at step 910, the electronic device may perform authentication of identification information described above with reference to FIG. 8.

If the identification information is effective as the result of the authentication at step 920, the electronic device may continue normal booting at step 930, and may output a notification related to the effective authentication of the identification information using at least one of audio, video, and a haptic output.

If the identification information is not effective as the result of the authentication, at step 940, the electronic device may stop the booting process or may perform the booting in a limited mode in which only a limited operation may be performed. In addition, the electronic device may output a notification for notifying that the identification information is forged or altered using at least one of audio, video, and a haptic output.

A method for causing an electronic device to authenticate identification information according to an embodiment of the present disclosure may include generating data related to first authentication information corresponding to the electronic device through decryption of an electronic signature that is received from an external electronic device; generating data related to second authentication information at least based on first identification information corresponding to the electronic device and second identification information corresponding to a CP of the electronic device; comparing data related to the first authentication information with data related to the second authentication information; and performing authentication of the electronic device at least based on the result of the comparison.

According to an embodiment of the present disclosure, the method may further include providing a notification corresponding to the result of the authentication.

According to an embodiment of the present disclosure, the data related to the first authentication information may include a hash value of the first authentication information, the method may further include generating a hash value of the second authentication information, and the performing of the authentication may include determining that the first identification information is effective if the hash value of the first authentication information is equal to the hash value of the second authentication information.

It will be understood that the above-described embodiments of the present disclosure facilitate understanding of the present disclosure and are not intended to limit the scope of the present disclosure. All modifications to the present disclosure are intended to fall within the scope of the present disclosure which is defined by the appended claims and their equivalents.

What is claimed is:

1. An electronic device, comprising:
a communication interface;
a memory configured to store first identification information corresponding to an external electronic device and second identification information corresponding to a communication processor (CP) of the external electronic device; and
a processor,
wherein the processor is configured to generate authentication information based on at least the first identification information and the second identification information,
generate an electronic signature corresponding to the authentication information through encryption of at least a part of data related to the authentication information, and
transmit the electronic signature to the external electronic device using the communication interface.

2. The electronic device of claim 1, wherein the processor is configured to transmit the electronic signature in combination with the first identification information to the external electronic device.

3. The electronic device of claim 1, wherein the processor is configured to receive a key value from another external electronic device using the communication interface, and
perform encryption using the key value.

4. The electronic device of claim 1, wherein the processor is configured to generate a hash value of the authentication information, and
generate the electronic signature through encryption of at least a part of the hash value of the authentication information.

5. A method of generating, by an electronic device, an electronic signature corresponding to authentication information of an external electronic device, comprising:
receiving, by the electronic device, first identification information corresponding to the external electronic device;
receiving, by the electronic device, second identification information corresponding to a communication processor (CP) of the external electronic device;
generating, by the electronic device, authentication information based on at least the first identification information and the second identification information;
generating, by the electronic device, an electronic signature corresponding to the authentication information through encryption of at least a part of data related to the authentication information; and
transmitting, by the electronic device, the electronic signature to the external electronic device.

6. The method of claim 5, wherein transmitting the electronic signature comprises transmitting the electronic signature in combination with the first identification information to the external electronic device.

7. The method of claim 5, further comprising receiving a key value from another external electronic device,
wherein generating the electronic signature includes performing encryption using the key value.

8. The method of claim 5, further comprising generating a hash value of the authentication information,
wherein generating the electronic signature includes generating the electronic signature through encryption of at least a part of the hash value of the authentication information.

9. An electronic device, comprising:
a communication interface including a communication processor (CP);
a memory configured to store first identification information corresponding to the electronic device, second identification information corresponding to the CP, and an electronic signature received from an external electronic device; and
at least one processor configured to generate data related to first authentication information corresponding to the electronic device through decryption of the electronic signature,
generate data related to second authentication information based on at least the first identification information and the second identification information,
compare data related to the first authentication information with data related to the second authentication information, and
perform authentication of the electronic device based on at least the result of the comparison.

10. The electronic device of claim 9, further comprising an output device,
wherein the at least one processor is further configured to provide a notification corresponding to a result of authentication of the electronic device through the output device.

11. The electronic device of claim 9, wherein the data related to the first authentication information includes a hash value of the first authentication information,
wherein the processor is further configured to generate a hash value of the second authentication information, and determine that the first identification information is effective if the hash value of the first authentication information is equal to the hash value of the second authentication information.

12. The electronic device of claim 9, wherein the processor is further configured to perform authentication of the electronic device in a booting process of the electronic device.

13. A method of authenticating, by an electronic device, identification information, comprising:
generating, by the electronic device, data related to first authentication information corresponding to the electronic device through decryption of an electronic signature that is received from an external electronic device;
generating, by the electronic device, data related to second authentication information based on at least first identification information corresponding to the electronic device and second identification information corresponding to a communication processor (CP) of the electronic device;
comparing, by the electronic device, data related to the first authentication information with data related to the second authentication information; and
performing, by the electronic device, authentication of the electronic device based on at least the result of the comparison.

14. The method of claim 13, further comprising providing a notification corresponding to a result of authentication of the electronic device.

15. The method of claim 13, further comprising generating a hash value of the second authentication information,
wherein the data related to the first authentication information includes a hash value of the first authentication information, and
wherein performing authentication of the electronic device includes determining that the first identification information is effective if the hash value of the first authentication information is equal to the hash value of the second authentication information.

16. The electronic device of claim 1, wherein the communication interface is configured to receive a secret key and/or a public key corresponding to the secret key from a key server to be used for encryption of authentication information.

17. The method of claim 5, further comprising receiving, by the electronic device, a secret key and/or a public key corresponding to the secret key from a key server to be used for encryption of authentication information.

18. The electronic device of claim 9, wherein the memory is further configured to store identification information corresponding to a CP in a second electronic device, wherein the identification information is written in a read only memory (ROM) at a time when the CP in the second electronic device is manufactured.

19. The electronic device of claim 18, the identification information corresponding to the CP in the second electronic device is a unique value that distinguishes the CP in the second electronic device.

20. The method of claim 13, further comprising storing, by the electronic device identification information corresponding to a CP in a second electronic device, wherein the identification information is written in a read only memory (ROM) at a time when the CP in the second electronic device is manufactured.
